(19) United States
(12) Patent Application Publication
(10) Pub. No.: US 2007/0127781 A1
(43) Pub. Date: Jun. 7, 2007

(54) Animal eye biometrics

(75) Inventor: Daniel E. Stewart, Henryville, IN (US)

Correspondence Address: Brooks & Cameron, PLLC, Suite 500, 1221 Nicollet Avenue, Minneapolis, MN, 55403, US

(73) Assignee: The International Performance Registry, LLC

(21) Appl. No.: 11/295,380

(22) Filed: Dec. 6, 2005

(51) Int. Cl. G06K 9/00; G06K 9/46

(52) U.S. Cl. 382/110; 382/190

(57) ABSTRACT

Methods, computer readable media, apparatus, and systems including program instructions are provided for animal biometrics. A method embodiment includes acquiring information about a physical characteristic of a pupil of an animal. The method also includes determining an identity of the animal, at least in part, by using the characteristic of the pupil.

### BACKGROUND

In the field of animal biometrics, it can be useful to determine a particular subject animal's identity by using identification or verification. Identification involves attempting to recognize an identity of a subject animal by comparing one or more physical characteristics of the subject animal with one or more physical characteristics of multiple particular candidate animals. Verification involves attempting to confirm a claimed identity of a subject animal by comparing one or more physical characteristics of the subject animal with one or more physical characteristics of one particular candidate animal.

It can be useful to use animal biometrics to identify and verify food animals and performance animals. Identifying food animals can reduce the risk of meat contamination, thus providing greater food safety. For example, using animal biometrics to identify cattle can reduce the risk of beef contamination. Verifying performance animals can provide increased certainty for purchasers and breeders. For example, using animal biometrics to identify a horse can provide increased certainty that the horse is a claimed horse with a particular bloodline.

A difficulty in animal biometrics can be finding physical characteristics of animals that can be measured for identification or verification yet not easily altered. An ear notch is an example of a physical characteristic of an animal that can be measured by human observation. However, an ear notch can be easily altered through tampering. DNA is an example of a physical characteristic of an animal that cannot be easily altered, since DNA is a distinctive genetic structure. However, DNA can be difficult to measure, requiring an expensive laboratory analysis of a blood or tissue sample taken from an animal.

### BRIEF DESCRIPTION OF THE DRAWINGS

FIG. 1 illustrates an embodiment of a method of acquiring animal biometric information according to the present disclosure.

FIG. 2 illustrates an example of an animal eye with a granula iridica.

FIG. 3 illustrates an embodiment of an apparatus that can be used in capturing an image of an eye of an animal according to the present disclosure.

FIGS. 4A-4B illustrate an embodiment of a system that can be used in capturing an image of an eye of an animal according to the present disclosure.

FIGS. 5A-5D illustrate an embodiment of a method of capturing and processing an image of an eye of an animal according to the present disclosure.

FIG. 6 illustrates an embodiment of a method for animal biometrics according to the present disclosure.

FIG. 7 illustrates another embodiment of a method for animal biometrics according to the present disclosure.

FIG. 8 illustrates still another embodiment of a method for animal biometrics according to the present disclosure.

FIG. 9 illustrates yet another embodiment of a method for animal biometrics according to the present disclosure.

### DETAILED DESCRIPTION

Embodiments of the present disclosure include methods, computer readable media, apparatus, and systems including program instructions are provided for animal biometrics. A method embodiment includes acquiring information about a physical characteristic of a pupil of an animal. The method also includes determining an identity of the animal, at least in part, by using the characteristic of the pupil.

Embodiments of the present disclosure described herein can be performed by software and/or firmware (i.e., computer executable instructions), hardware, application modules, and the like, executable and/or resident on systems, ASICs, and devices shown herein or otherwise. The embodiments of the present disclosure are not limited to any particular operating environment or to instructions written in any particular programming language. Software, firmware, and/or processing modules, suitable for carrying out embodiments of the present disclosure, can be resident in one or more devices or locations. Processing modules can include separate modules connected together or several modules on an application specific integrated circuit (ASIC).

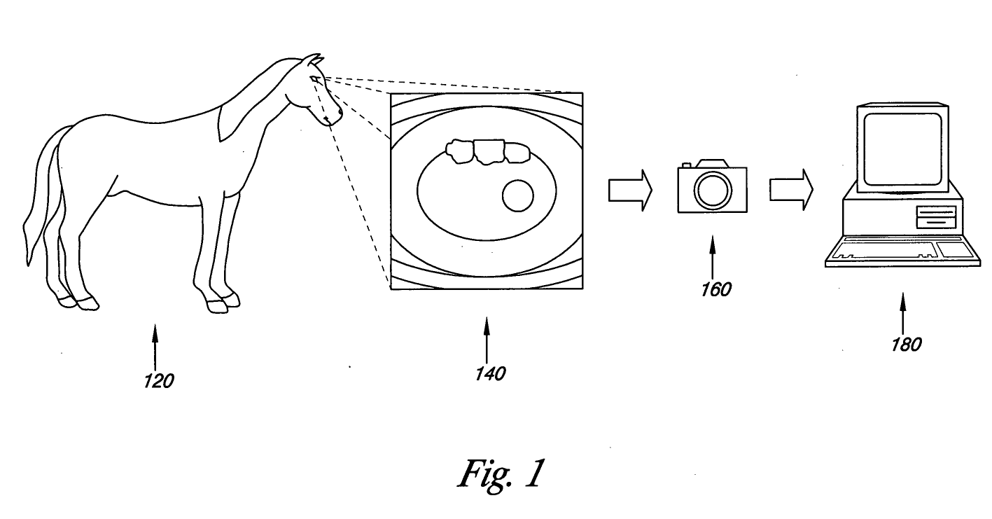

FIG. 1 illustrates an embodiment of a method of acquiring animal biometric information according to the present disclosure. The embodiment of FIG. 1 shows a subject animal 120, an image 140 of an eye of the subject animal 120, a camera 160, and a computing device 180. A subject animal is a particular animal with an identity to be determined by using identification and/or verification. In the embodiment of FIG. 1, the subject animal 120 is a horse, however embodiments of the present disclosure can be used for various animals.

The image 140 includes a pupil of an eye of the subject animal 120. Various embodiments of the present disclosure can be used for a right eye and/or a left eye of a subject animal. The pupil of the eye shown in the image 140 includes one or more physical characteristics that can be used to determine an identity of the subject animal 120. In FIG. 1, the eye in the image 140 includes a granula iridica. The eye in the image 140 is shown for illustrative purposes and is not intended to limit embodiments of the present disclosure to any particular kind of eye or any particular eye structure.

The camera 160 can capture the image 160 by taking a photograph. The camera 160 can be a film camera or a digital camera and can include a flash. The camera 160 is shown for illustrative purposes and is not intended to limit embodiments of the present disclosure to any particular kind of camera. The image 140 can be transferred to the computing device 180 in various ways, such as through electronic data transmission. The image 140 can be processed by the computer 180.

The computer 180 contains program instructions which can execute to process the image 140 and to determine an identity of the subject animal 120. Program instructions in the computer 180 can execute to process the image 140 to obtain information about one or more physical characteristics of the pupil of the subject animal 120. Program instructions in the computing device 180 can also execute to use this information to identify and/or verify the subject animal 120. For example, program instructions can execute to compare information about the subject animal 120 with information about one or more particular candidate animals. A candidate animal is a particular animal with a known identity that is associated with particular known information. Information that can be used to determine an identity of an animal can be obtained from an animal eye with a granula iridica.

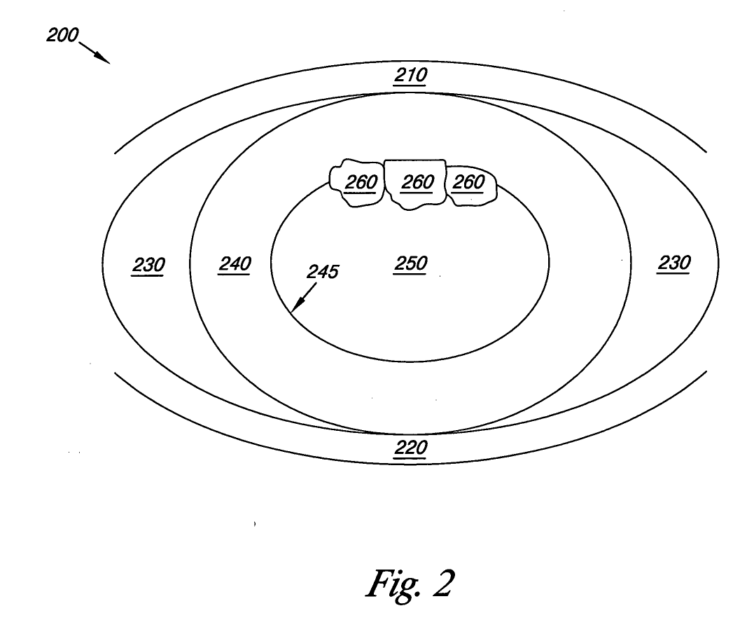

FIG. 2 illustrates an example of an animal eye with a granula iridica. The embodiment of FIG. 2 shows an animal eye 200 that includes an upper eyelid 210, a lower eyelid 220, a sclera 230, an iris 240, an iris-pupil boundary 245, a pupil 250, and granula iridica 260. The iris 240 is a muscularly operated diaphragm. At a center of the iris 240 is a hole that is the pupil 250. Light can enter the eye 200 through the pupil 250. The iris-pupil boundary 245 marks an edge between the iris 240 and the pupil 250. The iris 240, the pupil 250, and the granula iridica are internal structures of the eye 200, located behind a transparent surface called a cornea (not shown).

The iris-pupil boundary 245 includes the granula iridica 260. The granula iridica 260 are masses of iridial tissue that are attached to the iris 240. In this document, the term granula iridica 260 can refer to one or more masses of iridial tissue. The granula iridica 260 are also known as corpora nigra or iridic granules.

Granula iridica appear in eyes of various animals. Granula iridica appear in eyes of ruminant animals such as cows, goats, sheep, camels, llamas, giraffes, bison, buffalos, deer, wildebeest, and antelope. Granula iridica also appear in eyes of horses. Granula iridica can occur in different sizes, shapes, and locations for various animals. For example, granula iridica can be larger for camels and smaller for deer. Granula iridica can be more elongated for llamas and more rounded for horses. Granula iridica can appear on one side of an iris-pupil boundary for horses and on two sides of an iris-pupil boundary for cows.

A granula iridica can also have a unique size and shape for a particular eye of a particular animal. As a result, a granula iridica is a physical characteristic that can be used for identification or verification in animal biometrics. A granula iridica cannot easily be altered, since it is an internal eye structure. A granula iridica can be measured in various ways. Thus, a granula iridica can be used to determine an identity of an animal.

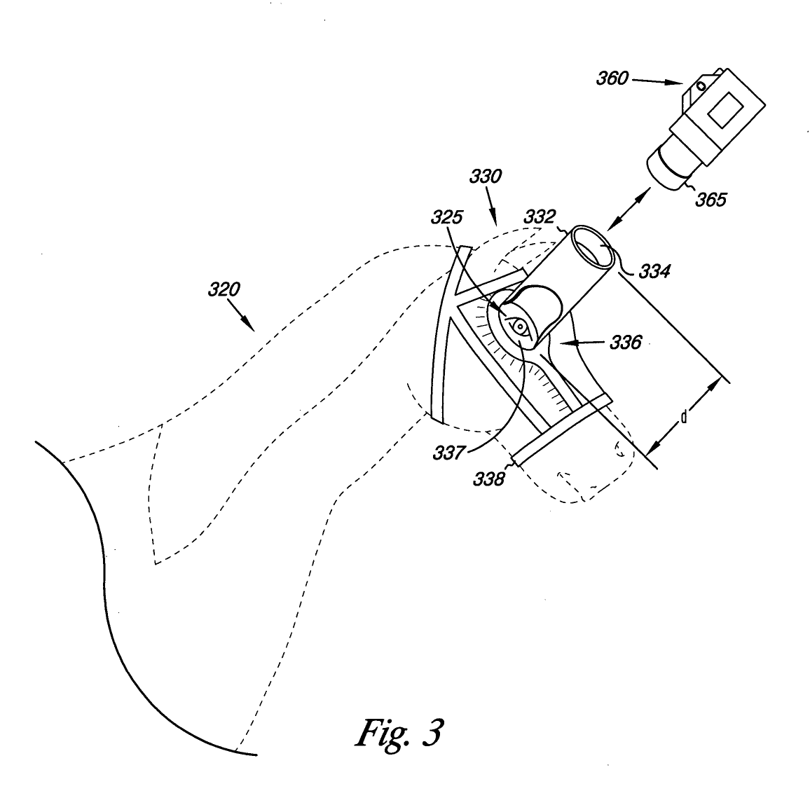

FIG. 3 illustrates an embodiment of an apparatus that can be used in capturing an image of an eye of an animal according to the present disclosure. The embodiment of FIG. 3 shows a head of an animal 320, a harness apparatus 330, and a camera 360. The animal 320 includes an animal eye 325. The harness apparatus 330 includes a camera tube 332, a top camera tube opening 334, a camera tube base 336, a bottom camera tube opening 334, and a harness apparatus strap 338. A portion of the camera tube 332 is shown as cut away to illustrate the location of the animal eye 325. The camera 360 includes a camera lens 365. In the embodiment of FIG. 3, the animal 320 is a horse, however various embodiments of the harness apparatus 330 can be used for various animals, such as the animals listed in connection with FIG. 2.

The harness apparatus 330 can be securely fastened to the head of the animal 320. In the embodiment of FIG. 3, the harness apparatus 330 securely fastens onto the head 320 with various straps, such as the harness apparatus strap 338. These various straps surround one or more portions of the head 320 and can connect with each other. Various embodiments of the harness apparatus 330 can include various configurations of straps. In some embodiments, the harness apparatus 330 can be fastened in other ways, such as through fabric that can wrap around the head of the animal 320. The harness apparatus 330 can be positioned on the head of the animal 320 so that the bottom camera tube opening 334 surrounds the eye 325 of the animal 320. Various embodiments of the harness apparatus 330 can be used for a right eye or a left eye of an animal. The camera tube 332 is a hollow tube, which can provide a line of sight from the animal eye 325 to the top camera tube opening 334.

The camera tube 332 can be connected with the camera 360 so that the camera 360 can take a photograph of the animal eye 325. This connection can be made in various ways. In an embodiment of the present disclosure, a portion of the camera lens 365 can be inserted into the top camera tube opening 334. In an embodiment of the present disclosure, a portion of a top of the camera tube 332 can be inserted into a housing on the camera lens 365. The camera tube 332 can be also connected with the camera 360 to establish a particular camera-to-subject distance, between the camera 360 and the animal eye 325. For example, the camera tube 332 can include an internal stop which can limit how far the camera lens 365 can be inserted into the top camera tube opening 334. This internal stop can be used to establish a particular camera-to-subject distance. An example of a particular camera-to-subject distance is shown as “d” in FIG. 3. As a result, the camera 360 can be used with the harness apparatus 330 to photograph the animal eye 325 at a particular camera-to-subject distance. This photograph can be processed and used to determine an identity of the animal 320.

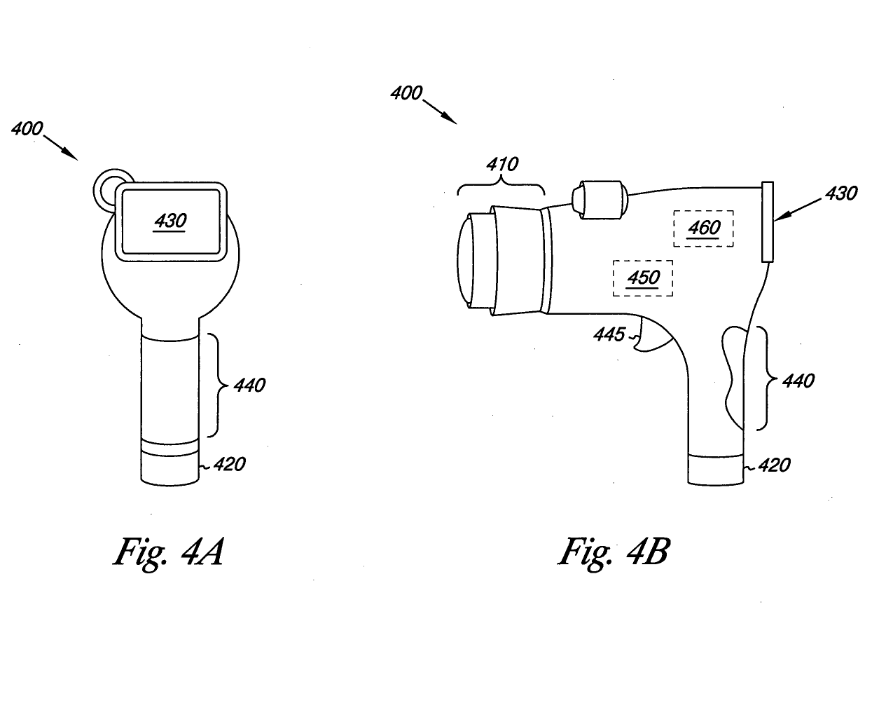

FIGS. 4A-4B illustrate an embodiment of a system that can be used in capturing an image of an eye of an animal according to the present disclosure. FIG. 4A illustrates a back view of the system 400 and FIG. 4B illustrates a side view of the system 400. The system 400 includes a camera lens 410, a communication apparatus 420, a display 430, a grip 440, a trigger 445, a processor 450, and a memory 460.

The camera lens 410 is part of a camera that is integrated into the system 400. This integrated camera can be a film camera or a digital camera and can include a flash. In an embodiment of the present disclosure, the camera lens 410 can be connected with the camera tube 332 of the harness apparatus 330 of FIG. 3 so that the integrated camera of the system 400 can photograph an eye of an animal at a particular camera-to-subject distance, as described in connection with FIG. 3.

In an embodiment of the present disclosure, the system 400 can be a handheld system. In this handheld embodiment, the grip 440 can have a size and shape that allow the grip 440 to be held by a human hand. The trigger 445 can configured so that it can be pulled by a finger on a human hand. The trigger 445 can provide one or more inputs to the system 400. For example, in an embodiment of the present disclosure, pulling the trigger 445 can provide an input to the system 400 that controls a shutter for the integrated camera. In various embodiments of the present disclosure, the system 400 can also include one or more other input devices such as a switch, button, key, knob, or dial.

The system 400 also includes a processor 450 and a memory 460. The memory 460 can store program instructions that can be executed by the processor 450. In an embodiment of the present disclosure, the memory 460 can store program instructions that are executable by the processor to capture an image, process the image, and determine an identity of an animal. In this embodiment, program instructions can execute to capture an image of a pupil of a subject animal, by using the integrated camera in the system 400. Program instructions can execute to process the image to obtain a physical characteristic of the pupil. Program instructions can also execute to determine an identity of the subject animal, at least in part, by using the physical characteristic.

The system 400 includes a communication apparatus 420. In the embodiment shown in FIG. 4B, the communication apparatus 420 is at a base of the grip 440; however the communication apparatus 420 can also be located on other parts of the system 400 or can be internal to the system 400. In various embodiments of the present disclosure, the communication apparatus 420 can send and/or receive various information to/from a device that is external to the system 400. As an example embodiment, the communication apparatus 420 can be a socket for connecting the system 400 to a docking station. As another example embodiment, the communication apparatus 420 can be a port for connecting an electronic data transmission cable, e.g. a universal serial bus (USB) cable. As still another example embodiment, the communication apparatus 420 can include a transceiver for wireless electronic data transmission.

In the embodiment shown in FIG. 4B, the display 430 is at a back of the system 400 and above the grip 440; however the display 430 can also be located on other parts of the system 400. In various embodiments of the present disclosure, the display 430 can display an indicator light, graphical information and/or text information. As an example embodiment, the system 400 can include an indicator light that can indicate a status of the integrated camera in the system 400. As another example embodiment, the system 400 can include an LCD panel that can display various texts, such as a prompt related to using the system 400, and various graphics, such as an image captured by the integrated camera.

In an embodiment of the present disclosure, the system 400 can include program instructions storable in the memory and executable by the processor so that the system 400 can receive information about a physical characteristic of a pupil of a candidate animal via the communication apparatus 420. The system 400 can include program instructions storable in the memory and executable by the processor to receive information about a user of the system in association with one or more particular candidate animals. For example, program instructions can execute to receive information about a pupil size of a candidate animal. In an embodiment of the present disclosure, the system 400 can also include program instructions storable in the memory and executable by the processor to present on the display 430 information about an identity of a subject animal. For example, program instructions can execute to present on the display 430 a name or number of a candidate animal with a pupil size that matches a pupil size of the subject animal.

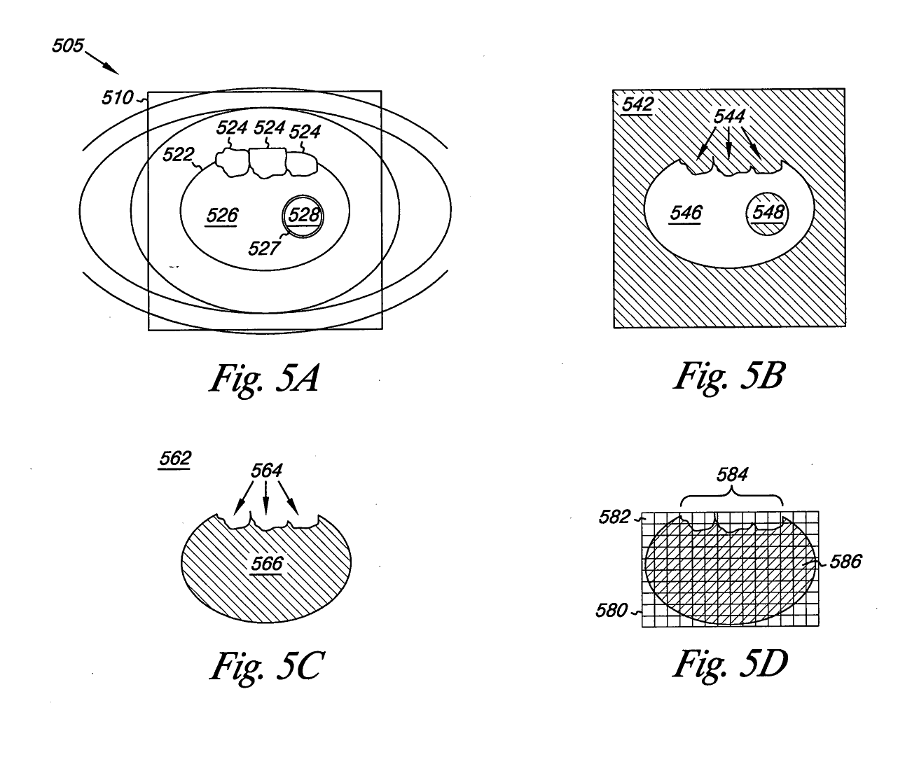

FIGS. 5A-5D illustrate an embodiment of a method of capturing and processing an image of an eye of an animal according to the present disclosure.

FIG. 5A illustrates an embodiment of a method of capturing an image of an eye of an animal according to the present disclosure. The embodiment of FIG. 5A shows an animal eye 505 with respect to an image border 510. The animal eye 505 includes an iris-pupil boundary 522, a granula iridica 524, and a pupil 526. FIG. 5A also shows a flash reflection 527 and a flash reflection area 528.

The image border 510, the flash reflection 527, and the flash reflection area 528 can result from capturing the image of FIG. 5A by using a camera. The image border 510 can result from a limited field of view of a camera at a particular camera-to-subject distance. The flash reflection 527 can result from flash photography. When flash photography is used to capture an image of an animal eye the flash can reflect off a cornea of the animal eye, resulting in a flash reflection in the image. The flash reflection area 528 is an area surrounded by the flash reflection 527. In an embodiment of the present disclosure, a camera and a flash can be positioned to capture an image of an animal eye so that a flash reflection in the captured image is shown within the pupil of the animal eye. This positioning can allow the flash reflection area 528 to be processed as a distinct area in the captured image. In various embodiments of the present disclosure, multiple images can be captured, to obtain this positioning.

FIG. 5B illustrates an embodiment of a method of processing an image of an eye of an animal according to the present disclosure. FIG. 5B shows a processed version of the image of FIG. 5A. The image of FIG. 5B shows an external area 542, a boundary portion 544, a partial pupil area 546, and a flash reflection area 548. The flash reflection area 548 represents an area inside the flash reflection 527. The partial pupil area 546 represents an area that is inside the iris-pupil boundary 522 and outside the flash reflection 527. The external area 542 represents an area that is inside the image border 510 and outside the iris-pupil boundary 522. The boundary portion 544 represents a portion of the iris-pupil boundary 522 that includes a shape of the granula iridica 524.

Program instructions can execute to form the image of FIG. 5B by performing image processing on the image of FIG. 5A. In an embodiment of FIG. 5B, program instructions can execute to define the external area 542 as a region of interest. Program instructions can execute to assign a common pixel trait, such as color, to pixels in the external area 542. Program instructions can also execute to calculate a size of the external area 542. The size of the external area 542 depends upon the size of the image border 510 and the size of the granula iridica 524. Since the granula iridica 524 has a unique size and shape, program instructions can execute to use the size of the external area 542 to determine an identity of an animal of the animal eye 505.

FIG. 5C illustrates an embodiment of a method of further processing an image of an eye of an animal according to the present disclosure. FIG. 5C shows a further processed version of the image of FIG. 5B. The image of FIG. 5C shows an inverted external area 562, a boundary portion 564, and a pupil area 566. The pupil area 566 represents an area that is inside the iris-pupil boundary 522, including the granula iridica 524. The external area 562 represents an area that is outside the iris-pupil boundary 522. The boundary portion 564 represents a portion of the iris-pupil boundary 522 that includes a shape of the granula iridica 524.

Program instructions can execute to form the second processed image of FIG. 5C by performing further image processing on the image of FIG. 5B. This further processing includes removing the flash reflection area 548 and inverting the image. In an embodiment of FIG. 5C, program instructions can execute to define the pupil area 566 as a region of interest. Program instructions can execute to assign a common pixel trait, to pixels in the pupil area 566. Program instructions can also execute to calculate a size of the pupil area 566. The size of the pupil area 566 depends upon the size of the pupil 526 and the size of the granula iridica 524. Since the granula iridica 524 has a unique size and shape, program instructions can execute to use the size of the pupil area 566 to determine an identity of an animal of the animal eye 505.

FIG. 5D illustrates an embodiment of a method of calculating the size a pupil area according to the present disclosure. FIG. 5D shows a pixel grid 580 overlaid on the pupil area 566. The embodiment of FIG. 5D shows the pixel grid 580, an exemplary open pixel 582, a boundary portion 584, and an exemplary filled pixel 586. The pixel grid 580 is shown for illustrative purposes and is not intended to limit embodiments of the present disclosure to any particular kind of eye or any particular eye structure. Program instructions can execute to calculate a number of filled pixels within the pixel grid 580. Program instructions can also execute to use the number of filled pixels to calculate a size of the pupil area 566. This technique can also be applied to calculate a size of the external area 542.

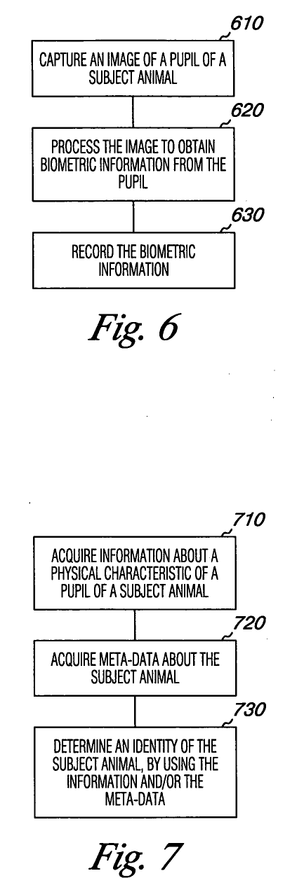

FIGS. 6-8 illustrate various method embodiments for animal biometrics according to the present disclosure. Unless explicitly stated, the method embodiments described herein are not constrained to a particular order or sequence. Additionally, some of the described method embodiments or elements thereof can occur or be performed at the same point in time.

FIG. 6 illustrates an embodiment of a method for animal biometrics according to the present disclosure. The method of FIG. 6 includes capturing an image of a pupil of a subject animal at block 610. Program instructions can execute to capture an image of a pupil of a subject animal. The image of block 610 can be captured as described in connection with FIGS. 3-5.

At block 620, the method of FIG. 6 includes processing the image captured at block 610 to obtain biometric information from the pupil of the subject animal. Program instructions can execute to process the image to obtain biometric information from the pupil. The biometric information of block 620 can include information about one or more physical characteristics of the pupil.

The method of FIG. 6 includes, at block 630, recording the biometric information obtained from the pupil at block 620. Program instructions can execute to record the biometric information. In various embodiments of the present disclosure, the biometric information can be recorded as one or more records in various formats, such as numerical values or database files, in various form of media, such as computer RAM or a computer disk.

FIG. 7 illustrates another embodiment of a method for animal biometrics according to the present disclosure. The method of FIG. 7 includes determining an identity of an animal using acquired information about a physical characteristic as well as acquired meta-data. At block 710 in FIG. 7, the method includes acquiring information about a physical characteristic of a pupil of a subject animal. Program instructions can execute to acquire information about a physical characteristic of a pupil of a subject animal. This subject information can be subject information about an iris-pupil boundary of an eye of a subject animal. The information of block 710 can be acquired in various ways, such as capturing an image or acquiring a record with biometric information.

The method of FIG. 7 includes, at block 720, acquiring meta-data about the subject animal of block 710. Program instructions can execute to acquire meta-data about the subject animal. The meta-data in block 720 can be meta-data about the physical appearance of the subject animal. In various embodiments of the present disclosure, the meta-data can be one or more images of the subject animal. For example, the meta-data can be one or more images of the subject animal's face, legs, side, or rear. The meta-data of block 720 can be acquired in various ways, such as capturing one or more images with a camera or through entry by a human. In various embodiments, the meta-data can include information about a user of the system, described herein, and/or an individual associated with one or more particular subject animals.

Block 730 includes determining an identity of the subject animal of block 710. The identity of the subject animal of block 710 can be determined by using identification or verification. Program instructions can execute to identify or verify the subject animal. The identity of the subject animal of block 710 can be attempted to be determined by using subject information acquired at block 710, meta-data acquired at block 720, or both subject information and meta-data.

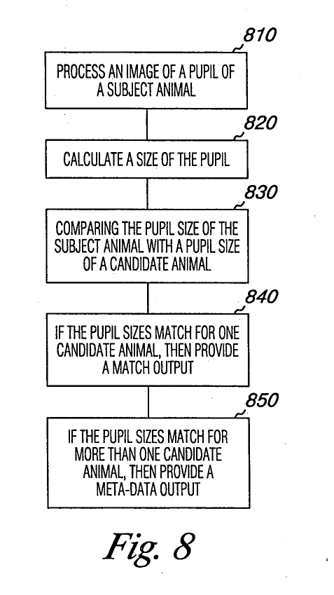

FIG. 8 illustrates still another embodiment of a method for animal biometrics according to the present disclosure. Block 810 includes processing an image of a pupil of a subject animal. The method of FIG. 8 includes, at block 820, calculating a size of the pupil in the image processed at block 810. At block 830, the method of FIG. 8 includes comparing the pupil size of the subject animal calculated at block 820 with a pupil size of a candidate animal. Block 840 includes providing a match output if the pupil size of the subject animal calculated at block 820 matches a pupil size of one candidate animal, based on the comparison from block 830. In various embodiments of the present disclosure, a match need not be an exact match but can be a match to a number within a particular range. For example, if a pupil size of a subject animal falls within a particular range of a pupil size of a candidate animal, then the subject animal can be considered a match with the candidate animal. The method of FIG. 8 includes, at block 850, providing a meta-data output about candidate animals if the pupil size of the subject animal calculated at block 820 matches a pupil size of more than one candidate animal, based on the comparison from block 830. Program instructions can execute to perform the processing at block 810, the calculating at block 820, the comparing at block 830, the providing of the match output at block 840, and the providing of the meta-data output at block 850.

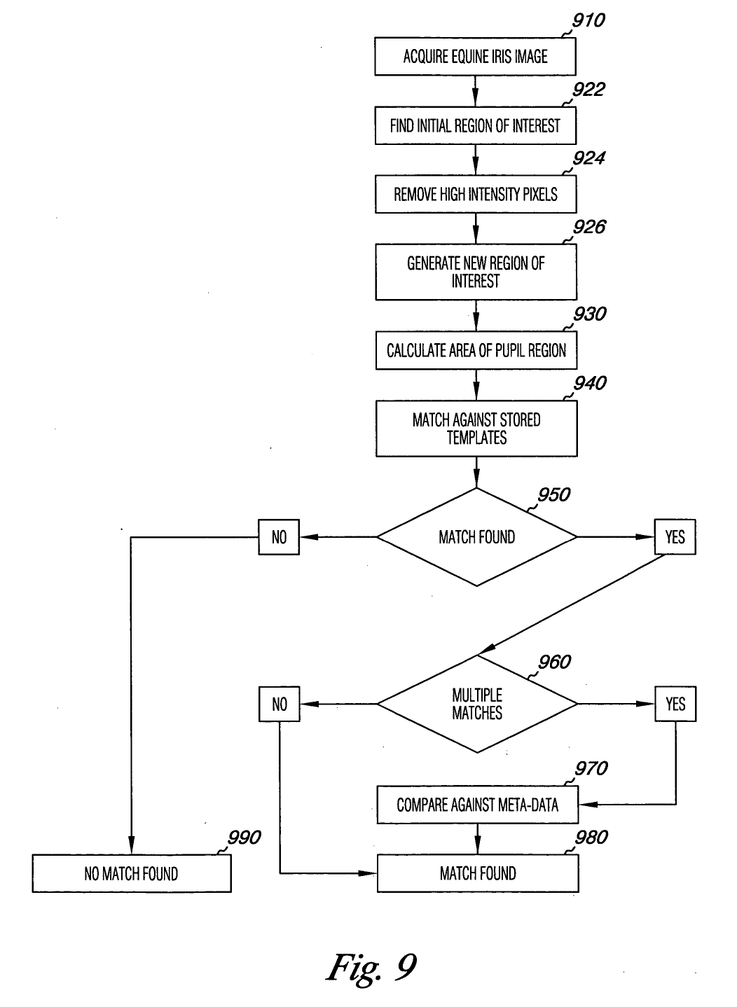

FIG. 9 illustrates yet another embodiment of a method for animal biometrics according to the present disclosure. At block 910, the method of FIG. 9 includes acquiring an equine iris image, which can be accomplished by capturing an image of an equine eye or by acquiring biometric information from a record. The method of FIG. 9 also includes, at block 922, finding an initial region of interest in the equine iris image of block 910. Program instructions can execute to find this initial region, which can be, for example, a pupil area of the equine eye or an external area related to the pupil area. Block 924 includes removing high intensity pixels from the equine iris image of block 910. Program instructions can execute to perform this removal, such as removing pixels related to a flash reflection in the image.

At block 926, the method of FIG. 9 includes generating a new region of interest in the equine iris image of block 910. Program instructions can execute to generate the new region of interest, for instance by performing further image processing on the image, such as inverting the image. The method of FIG. 9 also includes, at block 930, calculating an area of a pupil region in the equine iris image. Program instructions can execute to calculate the area, for example, by calculating a number of pixels in the area. Block 940 includes matching the calculated area of block 930 against stored templates that contain areas of pupil regions for particular animals. Program instructions can execute to conduct this matching, such as by performing a comparison between numbers representing the areas.

In the method of FIG. 9, Block 950 represents a decision point for the attempted matching at block 940. If no match was found at block 940, then program instructions can execute to provide an output at block 990 that no match was found. If a match was found at block 940, then program instructions can execute to continue to block 960. Block 960 represents another decision point in the method of FIG. 9. If no multiple matches were found at block 940, then at block 960 program instructions can execute to provide an output at block 980 that a match was found. If multiple matches were found at block 940, then at block 960 program instructions can execute to continue to block 970.

At block 970, meta-data from the multiple matches can be compared with meta-data for the horse that corresponds with the equine iris image of block 910. Program instructions can execute to compare this meta-data directly or to provide an output that contains meta-data from the multiple matches, for a comparison to be made by a human. Once this comparison is complete and all but one of the multiple matches is eliminated, the method proceeds to block 980, at which program instructions can execute to provide an output that a match was found. Thus, the method of FIG. 9 provides an embodiment for determining an identity of a horse through use of a calculated area of the horse's pupil region.

Although specific embodiments have been illustrated and described herein, those of ordinary skill in the art will appreciate that an arrangement calculated to achieve the same techniques can be substituted for the specific embodiments shown. This disclosure is intended to cover all adaptations or variations of various embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the present disclosure includes other applications in which the above structures and methods are used. Therefore, the scope of various embodiments of the present disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that embodiments of the present disclosure require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method for animal biometrics, comprising:
acquiring information about a physical characteristic of a pupil of an animal; and
determining an identity of the animal, at least in part, by using the characteristic of the pupil.

2. The method of claim 1, wherein determining the identity includes verification.

3. The method of claim 1, wherein determining the identity includes identification.

4. The method of claim 1, wherein:
acquiring the information includes acquiring information about a size of the pupil; and
determining the identity includes determining an identity of the animal, at least in part, by using the size of the pupil.

5. The method of claim 1, wherein:
acquiring the information includes acquiring subject information about a shape of the pupil; and
determining the identity includes determining an identity of the animal, at least in part, by using the shape of the pupil.

6. The method of claim 1, including:
acquiring meta-data about the animal; and
determining the identity of the animal, at least in part, by using the meta-data.

7. The method of claim 6, wherein:
acquiring the meta-data includes acquiring meta-data about the physical appearance of the animal; and
determining the identity of the subject animal, at least in part, by using the meta-data includes using the meta-data about the physical appearance of the animal.

8. A method for animal biometrics, comprising:
capturing a pupil image of an animal; and
processing the pupil image to determine a boundary portion of a pupil in the pupil image; and
using the boundary portion to determine an identity of the animal.

9. The method of claim 8, wherein capturing the pupil image includes photographing the pupil using a flash so that in the pupil image, a reflection of the flash is located entirely within the boundary portion of the pupil.

10. The method of claim 8, wherein capturing the pupil image includes capturing a pupil image that includes a granula iridica.

11. The method of claim 8, wherein capturing the pupil image includes capturing a pupil image of an animal selected from the group of:
a pig;
a cow;
a horse;
a ruminant.

12. The method of claim 8, including recording the pupil image in retrievable form for subsequent use in verification.

13. The method of claim 8, wherein capturing the pupil image includes photographing the pupil with a particular camera-to-subject distance.

14. The method of claim 13, wherein capturing the pupil image includes establishing the particular camera-to-subject distance by using a harness apparatus.

15. A computer readable medium having instructions for causing a device to perform a method, comprising:
processing an image of a pupil of an eye of a subject animal, wherein the eye has a granula iridica, to form a processed image including a shape of the granula iridica;
calculating a size of an area of the pupil in the processed image, to obtain a pupil size measurement of the subject animal; and
comparing the pupil size measurement of the subject animal with a pupil size measurement of a particular candidate animal.

16. The medium of claim 15, wherein the processing includes defining as a region of interest an area in the image that is bounded, at least in part, by an iris-pupil boundary of the eye, wherein the iris-pupil boundary includes the shape of the granula iridica.

17. The medium of claim 16, wherein the processing includes assigning a common trait to pixels of the image that are within the region of interest.

18. The medium of claim 16, wherein the calculating includes using the shape of the granula iridica.

19. The medium of claim 17, wherein the calculating includes calculating a number of pixels within the region of interest.

20. The medium of claim 15, wherein the comparing includes determining whether the pupil size measurement of the particular candidate animal is within a particular range of the pupil size measurement of the subject animal.

21. The medium of claim 20, wherein the method includes providing an output that indicates a match, if the pupil size measurement of the particular candidate animal is inside the particular range of the pupil size measurement of the subject animal.

22. The medium of claim 21, wherein the method includes:
comparing the pupil size measurement of the subject animal with pupil size measurements of a number of particular candidate animals; and
using meta-data about at least some of the particular candidate animals, if the pupil size measurements of more than one of the number of particular candidate animals is inside the particular range of the pupil size measurement of the subject animal.

23. A system, comprising:
a camera to record a pupil image of a subject animal;
a processor to receive a recorded pupil image;
a memory connected to the processor; and
program instructions storable in the memory and executable by the processor to:
process the recorded pupil image to obtain a physical characteristic of the pupil image; and
determine an identity of the subject animal, at least in part, by using the physical characteristic.

24. The system of claim 23, wherein the program instructions include instructions executable to receive information about a physical characteristic of a pupil image of a particular candidate animal and to compare the physical characteristic of the particular candidate animal to the physical characteristic of the subject animal.

25. The system of claim 24, wherein the program instructions include instructions executable to display the physical characteristic of the particular candidate animal with the physical characteristic of the subject animal.
